(19) United States
(12) Patent Application Publication
(10) Pub. No.: US 2012/0123890 A1
(43) Pub. Date: May 17, 2012

(54) System and method for augmenting a user environment with customized information

(76) Inventor: Timothy A. Nathan, Pittsburgh, PA (US)

(21) Appl. No.: 13/317,269

(22) Filed: Oct. 13, 2011

Related U.S. Application Data
(60) Provisional application No. 61/455,038, filed on Oct. 14, 2010.

(51) Int. Cl. G06Q 30/00

(52) U.S. Cl. 705/26.1; 705/1.1; 705/323

(57) ABSTRACT

A system and method is provided which utilizes wireless communications to provide a client with timed, geo-referenced information to augment the user experience in a physical environment. The present invention enriches the user environment by providing targeted information regarding the venue, products, services, customer services, social networking, gaming, targeted advertising, or safety.

### CROSS REFERENCE TO RELATED APPLICATIONS

The present invention claims priority under 35 U.S.C. §119(e) from U.S. Provisional Appln. No. 61/455,038 filed on Oct. 14, 2010, which is hereby incorporated by reference.

### BACKGROUND OF THE INVENTION

1. Field of the Invention

The present invention generally relates to the field of networking. More specifically, the present invention relates to the wireless delivery of customized information, which augments a user environment.

2. Description of the Related Art

Shopping at traditional “brick and mortar” stores and attending sporting/cultural events have suffered decreased attendance in recent years. Travelling to a physical venue such as a mall, store, shopping district, airport, school, hospital, theater, park, neighborhood, zoo, museum, convention center, tourist attraction, amusement park, or arena is often difficult. Traffic congestion, construction, poor weather, and increasing gas prices are all impediments to travelling to a venue. Aside from the potential difficulties with simply trying to get to a desired venue, once you reach your destination, you may find parking to be expensive, inconvenient and/or unavailable. Moreover, in the context of shopping, many stores for the sake of cost savings employ too few sales associates with little knowledge concerning the products and services available for purchase. To reduce inventory costs, many stores reduce the number of products stocked such that the particular item you desire may not be available. For parents and caregivers, there are safety and security concerns when minor children are taken to a venue. Many parents and caregivers fear that absent extreme vigilance a minor child could wander off and become lost. Children often lament the seemingly overbearing and constant monitoring they receive when out in the public at these types of venues. All of these potential problems detract from the enjoyment derived from visiting such venues. The result is that individuals may choose to minimize the amount of time spent visiting venues.

In the wake of the above noted issues, the variety of products and services available on the internet continues to grow at a staggering pace. The internet provides a number of advantages over traditional “brick and mortar” businesses. A user can log into an Internet retailer's store and shop from the comfort of their home. They do not have to spend the time or money to travel to a venue. Internet stores are rarely, if ever, closed. Safety and security concerns are reduced since you can access these online venues from home. Users can quickly comparison shop between various retailers for the best prices. For more information, a user can research customer reviews and browse through user manuals from manufacturers and the like. Retailers have also benefited. They are better able to provide targeted advertisements to users through the use of “cookies” or other similar tracking software. In addition, retailers may gather marketing and advertising information though surveys or even embedded into games and online entertainment, which creates a win-win for users and retailers.

Despite the advancements made with respect to providing internet-based products and services, something is lost by not visiting physical venues and personally interacting with the desired products and services. For instance, an internet-based retailer cannot provide a user a detailed view of how clothes will actually fit and look on a particular user. It is sometimes difficult to visualize the nuances of color or patterns in fabrics based on textual visual depictions of a product. Some purchasers may be reluctant to make a purchase without seeing and touching a product themselves, thus losing potential customers. For instance, the user can't experience how furniture feels when sat on or a stereo sounds. Watching a performance or sporting event online cannot provide a user with the same immersive experience achieved by physically attending a live event at a venue not to mention the psychological, physical, and emotional benefits derived from venturing out and interacting with people and the physical environment in the outside world. Moreover, once a purchasing decision has been made, for many goods, you will have to wait days or weeks for the products to be delivered. What is needed is a system and method that overcomes one or more of the deficiencies present in the art.

### SUMMARY OF THE INVENTION

One aspect of the invention relates to a system for augmenting a physical environment. The system includes a global positioning system and a master server. The master server includes a session manager, a communications manager and databases. A client is in communication with the master server. The client includes a user interface, a session manager, and a communications manager and a location manager. The client location is determined by the location manager. The communications manager permits communication between the master server and the client.

Another aspect of the invention relates to a system for augmenting a physical environment. The system includes a global positioning system and a master server. The master server includes a session manager, a communications manager and databases. A client is in communication with the master server. The client includes a user interface, a session manager, and a communications manager and a location manager. The client location is determined by the location manager. The communications manager permits communication between the master server and the client. The system also includes a routing manager which depicts a virtual environment. The virtual environment correlates with the location of the client in the physical environment based on the detected client location.

Another aspect of the invention relates to a system for augmenting a physical environment. The system includes a global positioning system and a master server. The master server includes a session manager, a communications manager and databases. A client is in communication with the master server. The client includes a user interface, a session manager, and a communications manager and a location manager. The client location is determined by the location manager. The communications manager permits communication between the master server and the client. The client device includes an associates' database of associated clients. The master server searches the physical environment and displays on the client device the location of the client's associates.

Another aspect of the invention relates to a system for augmenting a physical environment. The system includes a global positioning system and a master server. The master server includes a session manager, a communications manager and databases. A client is in communication with the master server. The client includes a user interface, a session manager, and a communications manager and a location manager. The client location is determined by the location manager. The communications manager permits communication between the master server and the client. The client device comprises a preference database including data about the client's preferences. The client preference data and the client location data are sent to the master server. The master server receives the client preference data and location data. The master server includes an advertisements manager, which selects an advertisement based on the client's location and preferences.

Another aspect of the invention relates to a system for augmenting a physical environment. The system includes a global positioning system and a master server. The master server includes a session manager, a communications manager and databases. A client is in communication with the master server. The client includes a user interface, a session manager, and a communications manager and a location manager. The client location is determined by the location manager. The communications manager permits communication between the master server and the client. The client submits a request to the master server to customer services. The master server forwards the request to the customer services server. The customer services server provides a response to the client.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not a limitation of the invention. In addition, it should be appreciated that structural features shown or described in any one embodiment herein can be used in other embodiments as well. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for augmenting a user's environment in accordance with an embodiment of the present invention.

FIG. 2 illustrates a schematic view of a client device in accordance with an embodiment of the present invention.

FIG. 3 illustrates a schematic view of a master server in accordance with an embodiment of the present invention.

FIG. 4 illustrates a schematic view of a location server in accordance with an embodiment of the present invention.

FIG. 5 illustrates a schematic view of a customer services server in accordance with an embodiment of the present invention.

FIG. 6 illustrates a global positioning system for locating a client in accordance with an embodiment of the present invention.

FIG. 7 illustrates a schematic view of a physical location in accordance with an embodiment of the present invention.

FIG. 8 illustrates a partial plan view of a physical location in accordance with an embodiment of the present invention.

FIG. 9 illustrates a partial plan view of an alternative physical location in accordance with an embodiment of the present invention.

FIG. 10A illustrates a representation of a client device depicting a first screen display.

FIG. 10B illustrates a representation of the client device depicting a second screen display.

FIG. 10C illustrates a representation of the client device depicting a third screen display.

FIG. 10D illustrates a representation of the client device depicting a fourth screen display.

FIG. 11 illustrates a top plan view of a store in accordance with an embodiment of the present invention.

FIG. 12 illustrates a partial front elevational view of a store in accordance with an embodiment of the present invention.

FIG. 13 illustrates a partial top plan view of a physical location in accordance with an alternative embodiment of the present invention with a kiosk.

FIG. 14 illustrates a partial top plan view of a physical location in accordance with an alternative embodiment of the present invention with a medical office, a security office, security officer, and a medical officer.

FIG. 15 illustrates a schematic representation of an entertainment manager in accordance with an embodiment of the present invention.

FIG. 16A illustrates a representation of a client device depicting a western theme.

FIG. 16B illustrates a representation of a client device depicting a space theme.

FIG. 17A illustrates a top plan view of an alternative physical environment in accordance with the present invention wherein the physical environment is a baseball stadium.

FIG. 17B illustrates a top plan view of an alternative physical environment in accordance with the present invention wherein the physical environment is a baseball stadium.

### DETAILED DESCRIPTION OF THE EXEMPLARY EMBODIMENTS

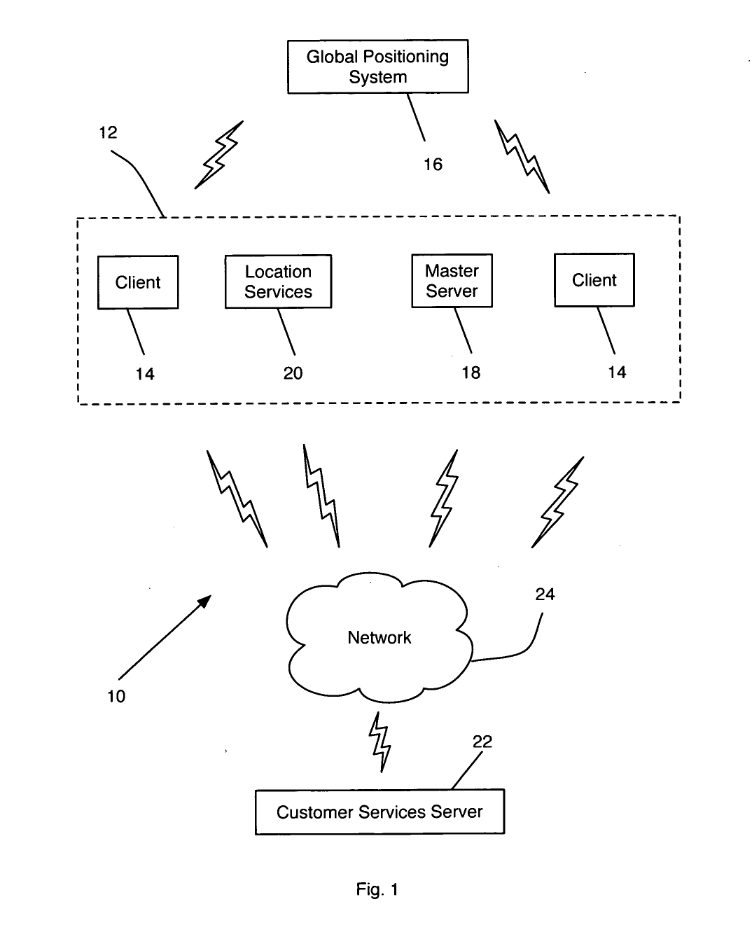

FIG. 1 illustrates a system 10 configured to augment a physical environment 12 with customized information. As used herein the physical environment 12 could be a variety of venues including but not limited to a mall, store, theater, arena, convention center, park, neighborhood, zoo, amusement park, tourist attraction, a portion of a city, a shopping district, a suburban area, an entire city, or other similar geographic region. Ultimately, as various venues are mapped out, the present invention could seamlessly encompass large geographic regions. In an embodiment, the present invention includes a client 14 in communication with global positioning system 16 and a master server 18. The system may include a local server 20 and a third party provider server 22. The system 10 may reside in the physical environment 12. Alternatively, the various servers (master server 18, local server 20, and third party provider server 22) may be remotely located from the physical environment 12 and in communication via a network 24. The network 24 could be a local area network or it could be a worldwide network such as the internet. In addition, the servers 18, 20 and/or 22 may be separate from the global positioning system 16 or the servers and the global positioning systems may be located together or combined into a single device as described in more detail below.

### A. Hardware

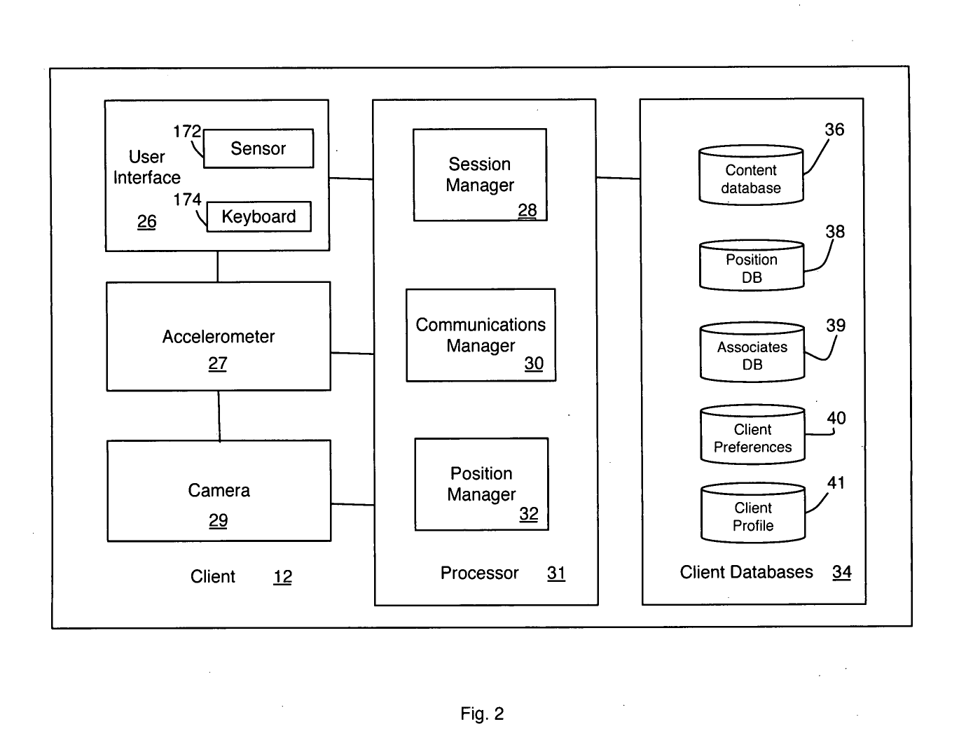

With reference to FIGS. 2-6, the client 14 includes a user interface (UI) 26, an accelerometer 27, a camera 29, a processor 31, a session manager 28, a communications manager 30, and a position manager 32. Each of these managers may store data in one or more databases 34. The databases 34 may include a content database 36, a position database 38, client preference database 40, and client profile database 41. A variety of devices may be used as the client 14. The applicant contemplates that the client 14 could be a mobile wireless device such as a Blackberry device (a trademark of Research In Motion Ltd.), and Android device (trademark of Google Inc.), a Symbian device (trademark of Nokia), a Windows Mobile device (trademark of Microsoft Inc.), an iPad/iPhone device (trademarks of Apple Inc.), a portable computer such as a laptop or even a desktop computer. In addition, with the rise of 3D televisions, the client could also be a 3D television or a wearable device that provides 2 dimensional or 3 dimensional images to a pair of goggles, an armband, or other wearable device. One of ordinary skill in the art can appreciate that a variety of devices using a variety of platforms could be used without departing from the unique aspects of the present invention.

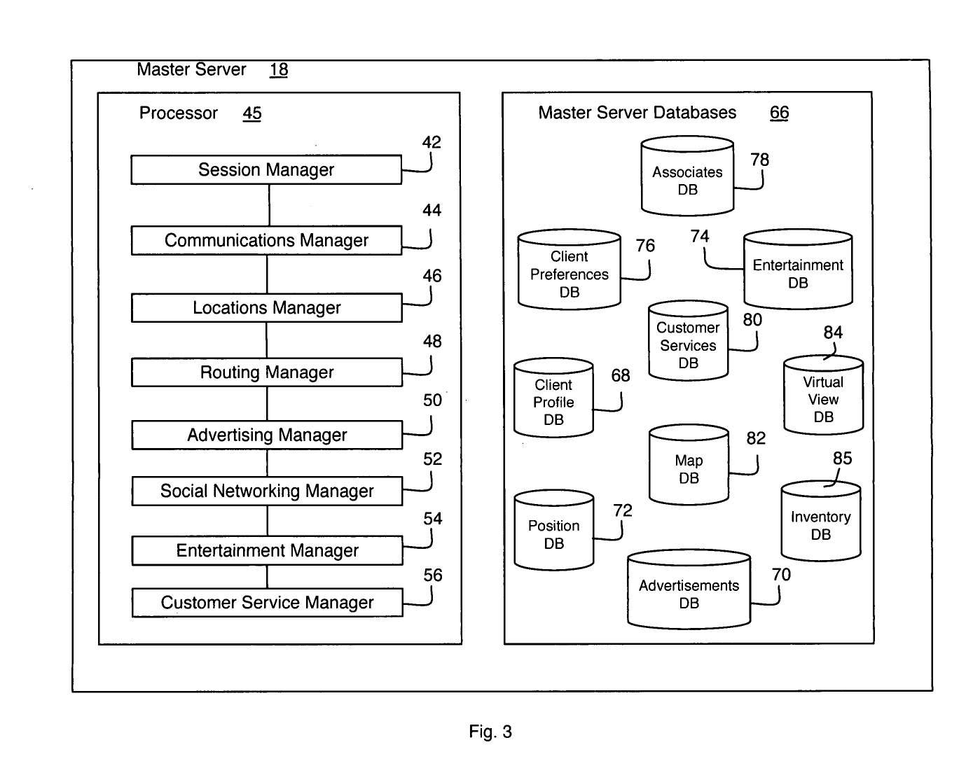

As seen in FIG. 3, the master server 18 includes a processor 45 with a variety of management services. Similar to the client device 14, the master server 18 includes a session manager 42, a communications manager 44, and a position manager 46. In addition, the master server 18 includes a routing manager 48, advertising manager 50, social networking manager 52, entertainment manager 54, and a customer services manager 56. Each of these managers may pull data from master server databases 66 such as a client profile database 68, advertisement database 70, position database 72, entertainment database 74, preference database 76, associated client database 78, customer services database 80, map database 82, and virtual view database 84.

The routing manager 48 provides routing information to the client 14 as well and capture the client's track through the user environment 12. The client's position data, and time that the client was at the detected position is stored in the position database 72. This data can be used in a variety of manners. For instance, the latest position of the client can be used to determine the current location of the client 14 and the client's 14 proximity to other items within the environment. The historical data of detected positions can be used to generate a track of where the client 14 has been as they navigate through the physical environment 12. In addition, the difference between two positions (P2-P1) divided by the difference in time (T2-T1) it took to move between the two points can be used to calculate the rate, R, as the client is moving through the environment. Generally, this data could be used in a predictive manner to forecast where the client is likely to be at a future point in time, so that information can be directed to a future location in the physical environment as described below in more detail. The current position, Pc, and the past rate, R, can be used to forecast a potential future location, Pf, at time, Tf.

R=(P2−P1)/(T2−T1) (1)

Pf=Pc+R*Tf (2)

The advertising manager 50 is used to coordinate and provide the client 14 with real time advertisements. The advertisement manager 50 customizes and provides advertisements based on the detected time, position of the client, and/or proximity to various items in the physical environment. The social networking manager 52 is used to provide the client 14 with the capability to perform social networking, which allows the clients to interact with each other as well as with other individuals. However, unlike online chat services or social networking sites which require you to search and find a page of interest. The present invention contemplates that the available social networking available may be customized based on the client's detected position within the environment. For instance, the social network can be customized based on the client preference data, location, and/or proximity to other clients or items in the physical environment. The entertainment manager 54 provides one or more different games and entertainment programs for use by the client 14. The customer services manager 56 provides customer services to the client 14.

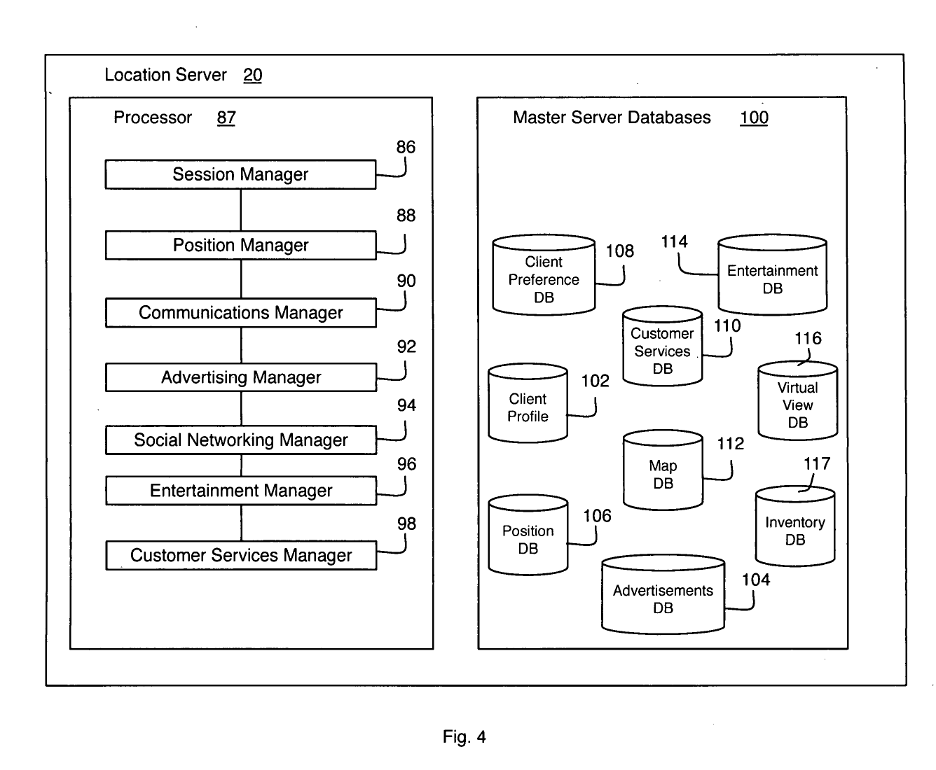

As seen in FIG. 4, the location server 20 of the present invention includes a processor 87 including a session manager 86, a position manager 88, and a communications manager 90. The location server 20 also includes an advertising manager 92, a social networking manager 94, an entertainment manager 96 and a customer services manager 98. Each of the managers access one or more location server databases 100. The databases 100 include a client profile database 102, an advertisement database 104, a location database 106, a preference database 108, a customer service database 110, a map database 112, an entertainment database 114, and a virtual view database 116. The location server 20 may be the only server at a location such as a store or park. Alternatively, the location server may manage a sub-portion of the information at a particular physical location. This would provide a store with the access and ability to manage a subset of the information within a physical environment.

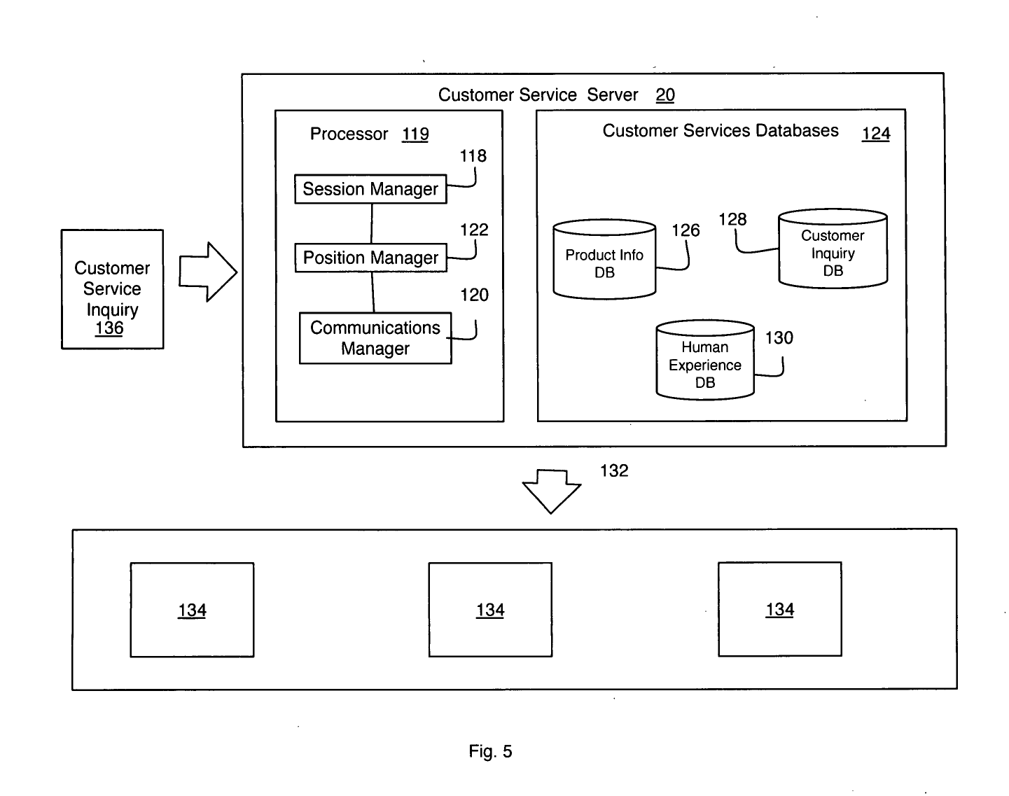

The customer service server 22 is shown in FIG. 5. The customer service server 22 includes a processor 117 including a session manager 118, a communications manager 120 and a position manager 122. The managers 118, 120, and 122 access databases 124. The databases 124 include a product information database 126, a human experience database 128, and a customer inquiry database 130. The customer service server 22 routes communications over link 132 to a pool of customer service representatives 134. The server 22 routes communications to the customer service representatives 134 such that the communications are taken in the order received. Alternatively, an incoming customer service inquiry could be categorized and stored in the customer service inquiry database 128. The inquiry could be correlated with product information contained in the product information database 126 and sent to back to the client 14 via communications manager 120 over network 24. Alternatively, the inquiry could be correlated with an expert 134 as contained in the human expertise database 130. The human expertise data contained in the database may include a look up table which correlates an incoming customer service inquiry 136 with a expert 134 based on a variety of criteria including the product , class of products, type of inquiry (e.g., sales information, product functionality information, troubleshooting information, configuration information, product availability information, ordering information, service information, etc.). The link 132 can be any link which is capable of relaying the customer inquiry and returning information from the expert 134. The link with the expert includes, without limitation, voice communications (telephone, voice over IP, videoconference), data communications (text messages, emails, etc.).

The location server 20 and customer service server 22 share some commonality with the master server 18. One or more location servers 20 and customer service servers 22 may or may not be needed depending on the particular application of the present invention. While the managers and the databases have been discussed as discrete items, this has been done for the purposes of clarity to describe functionality. One of ordinary skill in the art can appreciate that the various managers may be collocated or remotely located relative to one another in the server or in a separate remote server. Similarly, the databases may be collocated or remotely located relative to one another within the server or in a separate remote server.

### B. Position Detection

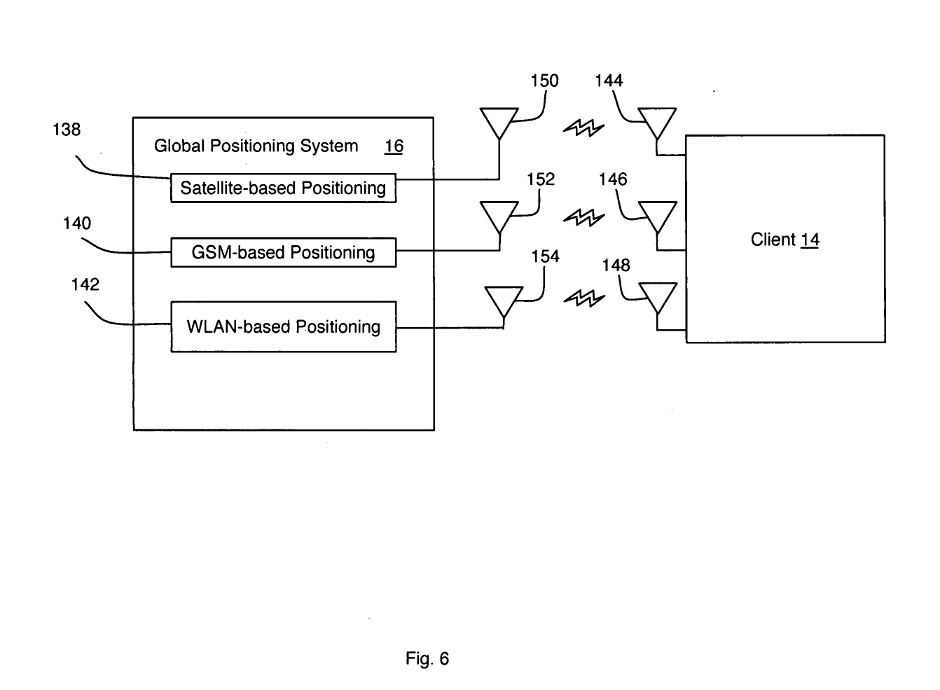

As seen in FIGS. 2 and 6, the position manager 32 of the client 14 may detect the client's location within the physical environment 12 via a variety of global positioning systems 16. As used herein, the term global positioning system 16 is broadly used to refer to any system, which can be used for geospatial locationing. For instance, the client 14 may include a receiver 144 to communicate with a satellite based positioning service 138, which transmits one or more signals via a transmitter 150. To increase accuracy, this signal may be augmented including a variety of schemes, including but not limited to, a wide area augmentation system (WAAS). The client 14 may also be able to detect its location via terrestrial-based positioning 140 such as that available via global system for mobile communications (GSM) networks, which rely on terrestrial based towers. This system uses a transceiver 152 located at the tower in communication with a transceiver 146 located with the client 14. Finally, the global positioning system 16 could utilize a wireless local area network (WLAN) based positioning system 142. This system 142 also includes a transceiver 154 in communication with a transceiver 148 located at the client 14. Of course, a variety of other positioning systems may be used without departing from the present invention.

A relatively high degree of positioning accuracy would be advantageous when implementing the present invention. To complicate this situation, at least some of the potentially desirable physical environments 12 contemplated by the inventor are indoors and congested urban areas, which are well known to present challenges to accurate global positioning. To ameliorate this potential problem, the present invention contemplates that more than one of the global positioning systems 16 mentioned above could be used to locate a client 16. For instance, the redundancy of global positioning systems 16 could be used by the client 14 to select the most reliable global positioning system 16 for a particular physical environment 12. If the information received from one of the global positioning systems become erratic, weak, undetectable, or otherwise unreliable, the client 14 could switch to one of the other global positioning systems 16. Alternatively, the client 14 could aggregate and compare the information derived from the different global positioning systems 16 to increase the position locating accuracy of the client 14. For instance, the data from multiple global positing systems 16 could be averaged to reduce the error. Alternatively, if two of the global positioning systems approximately agree and the third one is significantly different, the location data from the third global positioning system could be discarded. The information from the remaining global positioning systems could be averaged to minimize the error for each system. Of course, a variety of other schemes could be used to increase accuracy.

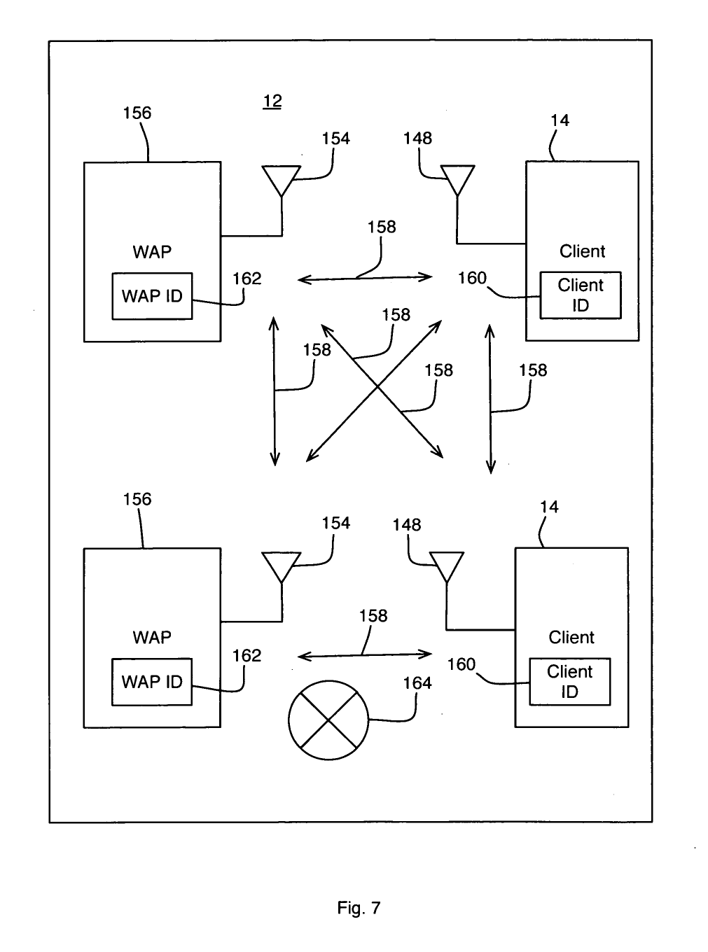

Given that it may be desirable to utilize the system 10 in potentially challenging physical environments 12, the inventor contemplates that a system built upon a wireless local area network 142 may provide a great deal of promise. A physical environment could be fitted with one or more wireless access points (WAP) 52, as shown in FIG. 7. As used herein, a wireless access point or WAP shall be interpreted to mean a device capable of communicating with clients 14 which may include one or both of access to a network and a global positioning system. The client 14 may be located through a variety of techniques. For instance, the client 14 may receive a signal 54 which includes time delay information, which is essentially the time it takes for a signal to travel between two points, or signal latency. This signal 54 may be a one-way signal (from one location to another) or a round-trip signal (from one location to another and back to the originator) which could be sent from the client 14 to detected WAPs 156 or from the WAPs 156 to the client 14 and back. Each client 14 includes a client ID 158. Each WAP 156 includes a WAP ID 162, which may be correlated with the time delay calculated by the signal latency. By processing the time delays between various WAPs, the location of the client may be detected to the extent that the location of the WAPs is known within a reasonable level of certainty. Processing the latency between the WAPs and the client 12 may be accomplished on either device, the master server 18, the location server 20 or by another remote server, not shown.

Alternatively, or in conjunction with latency position detection, the present invention contemplates that the position of the client 14 in a physical environment 12 may be further determined by signal strength detected between the client 12 and proximate WAPs 156. Generally, the location of the client may be discerned by detecting which WAPs 156 are detectable. Given an adequate matrix of WAPs 156, the location of the client 14 may be broadly determined based on which WAPs 156 are detected. Although this detection scheme provides rather low resolution, it could be used to generally locate the device, which might be useful to determine if the client is generally in the physical environment while requiring little or processing time. Greater accuracy may be achieved by determining the signal strength from each of the WAP 156 signals. Processing of the signals may occur at the WAP 156, the client 12, the master server 18, the location server 20, elsewhere in the physical environment 12 or elsewhere by a remote server, not shown.

To enhance the quality of position detection, a physical environment 14 may be mapped out with a matrix of detected signal strengths and/or latencies. This may be achieved by manual detection though use of a human directed survey at various locations through the physical environment. For instance, a person could move through the physical environment and map out a grid of locations and associated detected locations via signal strength and/or latency by using a device, not shown, to detect signal strength and/or latency. Alternatively, the location of each WAP 156 may be surveyed into a map of the physical environment 12 which may be desirable since the WAPs 156 are static and do not move. The distances between each WAP 156 can be easily determined. Therefore, variations in signal latency or signal strength between the WAPs could be used to create a real-time self-adapting grid of locations where particular signal strengths represent known distances. For instance, if at one time, the signal strength received from a given WAP was calculated at 90% by a neighboring WAP 156, which was known to be 50 feet away. If at a subsequent time, the strength is calculated as 85%. The WLAN matrix can be recalibrated since the location of the stationary WAPs has not changed. 85% signal strength now represents a distance of 50 feet between the two surveyed locations. Similarly, if the round-trip latency of the signal is detected at 0.5 seconds at one time between two WAPs known to be 50 feet apart and at a subsequent time 0.4 seconds, a latency of 0.4 seconds represents a distance of 50 feet. This data may be used specifically for calculations using these two WAPs, in the vicinity of these two WAPs, or potentially as a weighting factor to recalibrate the positioning matrix within the physical environment.

Although the preferred embodiment of the invention is that the WAPs 156 may be configured to provide both global positioning information to the clients 14 and information through connection to the internet, or local network, the inventor contemplates that in some physical environments 12 at least some of the WAPs could be configured, or defeatured, to provide only one of the above features in an effort to increase efficiency and reduce cost. For instances, some of the WAPs 156 may only provide global positioning while others may provide only content, while still others may provide both positioning and content.

In addition, the inventor contemplates that the accuracy of the system could be improved whether using latency or signal strength detection by incorporating one or more surveyed locations within the physical environment for calibration by the client. The user could stand in one or more calibration locations 164 within the physical environment 12 and run a calibration process. Specifically, the inventor contemplates that the user could select a calibration location 164, stand on the particular calibration location 164, and run a calibration process. This feature would detect the signals from one or more WAPs 162. Since the precise location of the client 14 and the detected WAPs are known, the detected signals 158 may be used to calibrate the client device 12. Advantageously, this method would allow for the system to account for manufacturing variations between different clients 14 and WAPs 156, variations based on changes in the physical location 12 such as items in the environment that interfere with the signal 158, time dependent variations of the devices 14, 156 at a given time, degradation of the devices 14, 156.

Still further, the inventor contemplates that a given physical environment may include multiple clients 14 at any given time. Accordingly, each client 14 may be programmed to pass location information to other detected clients 14 within the physical environment 12. As can be best appreciated by one of ordinary skill in the art, three references are needed to positively locate an item in three dimensional space. Additional data from other sources helps to increase accuracy and detect faulty signals 158. Through location information redundancy, the accuracy of the global positioning 16 within a physical environment 12 may be increased as the number of clients 14 within the physical environment increases. Or, the clients may be able to in effect “daisy chain” accurate location information based on a client inside or outside the physical environment 12 or in another location with accurate positioning. For instance, a few clients 14 outside receiving a reliable signal from a satellite-based global positing system 16 could be used to triangulate with a client 14 near the entrance of the mall, which may be used to triangulate with another client further within the mall and so on. Alternatively, if the client data from a calibration location 164 can be passed to other clients 14 within the physical environment 12, the system 10 can be recalibrated frequently as clients utilize the calibration location 164. This function could be incorporated into entertainment as discussed in more depth below. For example, with respect to calibration of the system 10, the users could participate in a game, which asks them to find and stand in a particular location, and indicate the location has been found (e.g. press a button on user interface of the client device 14, a WAP 154, or other device capable of sending a signal).

### C. Shopping Example

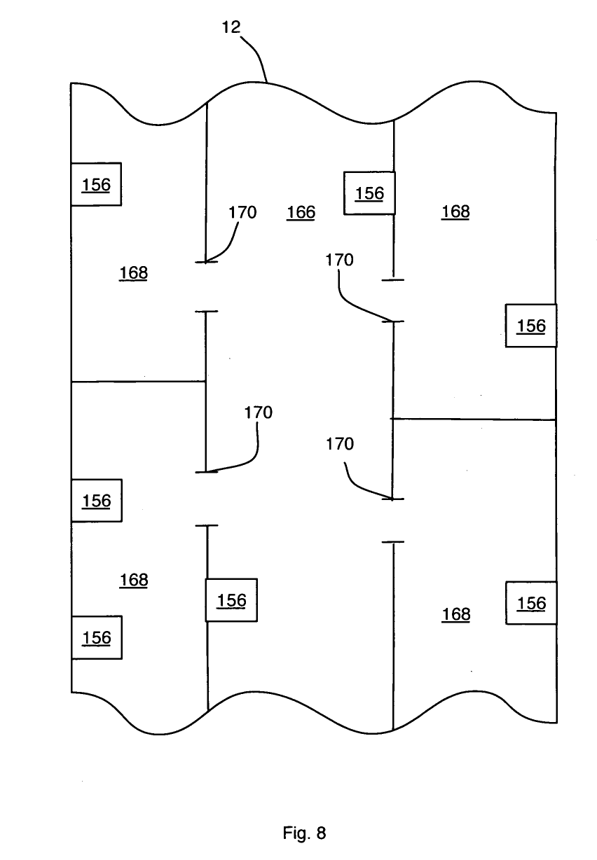

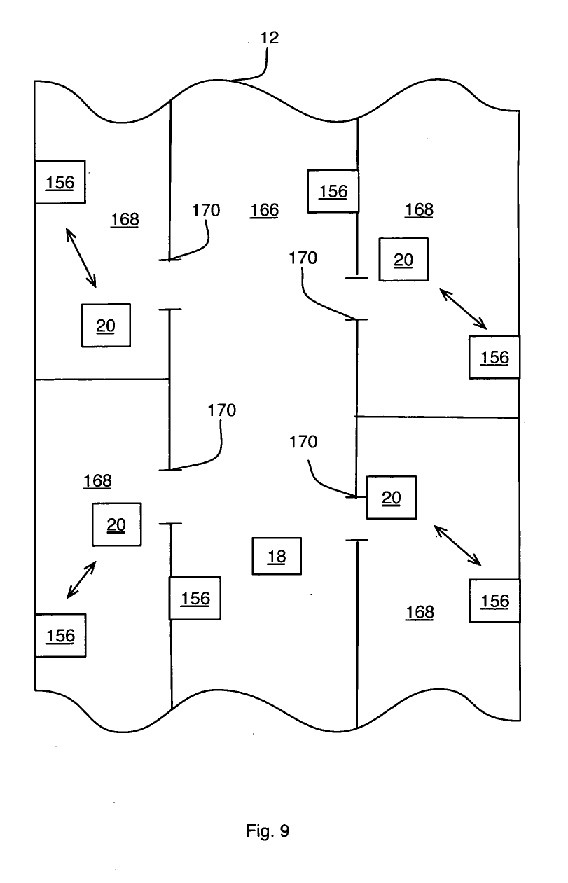

By way of example, FIG. 8 shows a partial plan view of a shopping mall as the physical environment 12 having a hallway, or concourse, 166 and stores 168 which may be accessed via a doorway 170. In the given example, each of the stores 168 and concourses 166 include one or more WAPs 156. Of course some stores 168 may require numerous WAPs 156. While other stores 168 may find that they do not need to install any WAPs 156 to provide adequate coverage based on the existing WAPs 156. As seen in FIG. 9, the stores may each include location servers 20 while the mall may include master server 18. However, in alternative embodiments, these servers 18, 20 may be remotely located as well. Aside from locating the client 14, the client 14 may send and receive information while navigating through the physical environment 12. The data communications are managed by the communications manger 30 (FIG. 2), the communications manager 44 (FIG. 3), and/or the communications manager 90 (FIG. 4). The inventor contemplates that this may be achieved by data service provided over terrestrial based communications systems such as GSM networks, or over wireless local area networks such as WLANs accessed via the WAPs 156. The inventor contemplates that a multitude of networks could be utilized. The network 24 could be a local area network. However, it is presently preferred that the communications managers 30, 44, and 90 would be connected by the internet.

Once the client is located in the physical environment 12 and data can be sent and received, a variety of applications are possible which would augment the users experience while present in the physical environment 12. As seen in FIG. 2, the client session manager 28 manages the interactive client session coordinating content data 172 from the communications manager 30 and position data 174 from the position manager 32. The content data 172 is formatted by the session manager 28. The user can interact with the session manager 28 via the user interface 26. The user can send requests for content data 174 over the network 24 via the communications manager 30 which may be stored in content database 40.

### 1. Routing

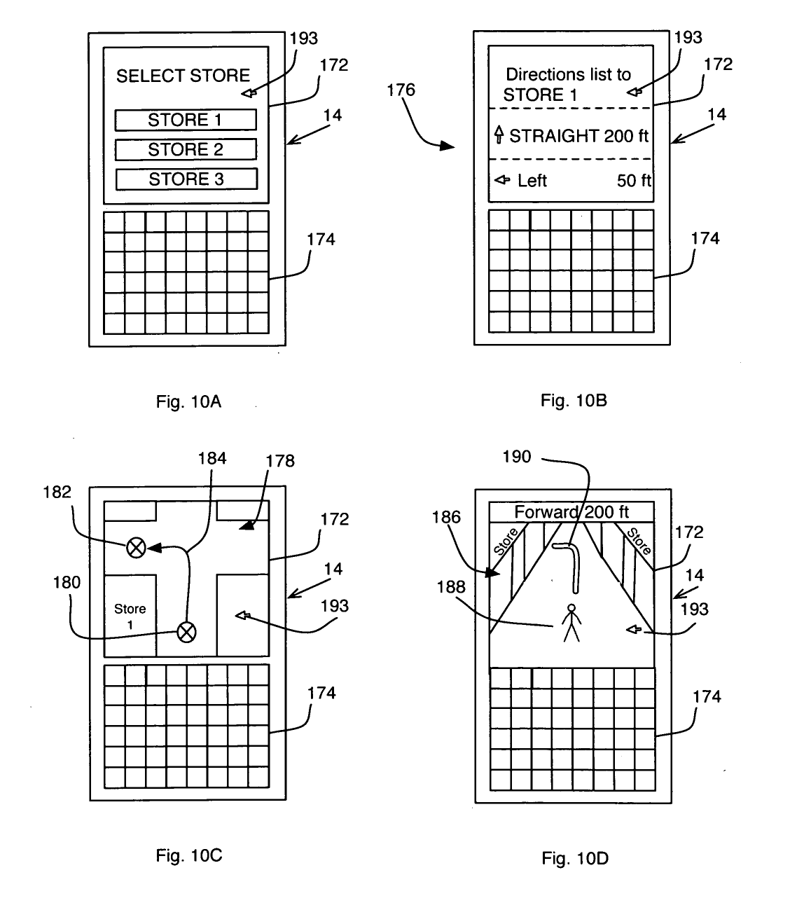

The system as described above can be used to synergistically provide a rich user experience. The client 14 may utilize the routing manager 48 to provide routing information to a particular location within the physical environment 12. For instance, the location could be to a particular store 168 (FIG. 8) in a mall. The client 14 could be presented with a list of stores 168 available in the mall. They user may select the desired store 168 (FIG. A), and the directions to the store 168 may be displayed on the user interface 26 in a variety of manners. The directions may be a simple list of directions 176 (e.g., forward 200 ft, take a left turn, 50 feet) (FIG. 10B). Or, the directions may be displayed on a 2 dimensional plan view 178 of the physical location 12 based on data received from the map database 100 (FIG. 10C). The plan view 178 shows the physical location and includes a current location icon 180, a destination icon 182, and a path 184 to the destination 182.

The master server 18 may also include an eye level, or virtual view, database 102. This database may include eye level views of the physical environment 12. This database may provide a view similar to Google Streetview tm. However, Google Streetview tm is commonly used in an environment remote from the environment being viewed virtually and navigated by the user inputting desired movements to virtually travel through the virtual environment. In the present invention, motion though the eye level view is achieved by detecting the motion of the client 12 in the physical environment, which results in updating the view depicted in the virtual environment. In this way, the user can compare the real world location with the eye level view depicted on the user interface 26 thus reducing the interpretive issues some users may have when attempting to navigate based on more abstract directions provided by 2D plan views, or turn-by-turn directions. As seen in FIG. 10D, the client 14 can display a virtual view 186 which depicts the current location 188 of the client and the path 190 to the desired location, not shown. The current location could be a simple icon to represent location or it could be more stylized showing a virtual view of the user, or an avatar. The eye level view may include information to essentially augment the real world. The eye level view may include information about the stores being passed, products contained in the windows, etc.

The user can select a store 168 in any of the above referenced views with the curser 192 to obtain more detailed information about the store 168. The information could be stored on the master server 18 or the location server 20 associated with a particular store 168. The information may include store hours, sales events, future events, coupon offers, etc. As discussed below, this information may be customized to the client based on the client's profile and preferences.

The routing manager 48 may also be programmed with a list of products and services available within the physical environment. Therefore, if a user is looking for a particular product (e.g., a size 12 pair of blue jeans, or a pair of LEVI tm blue jeans) or a particular service, they can be routed to the store 168, which has that particular product or service.

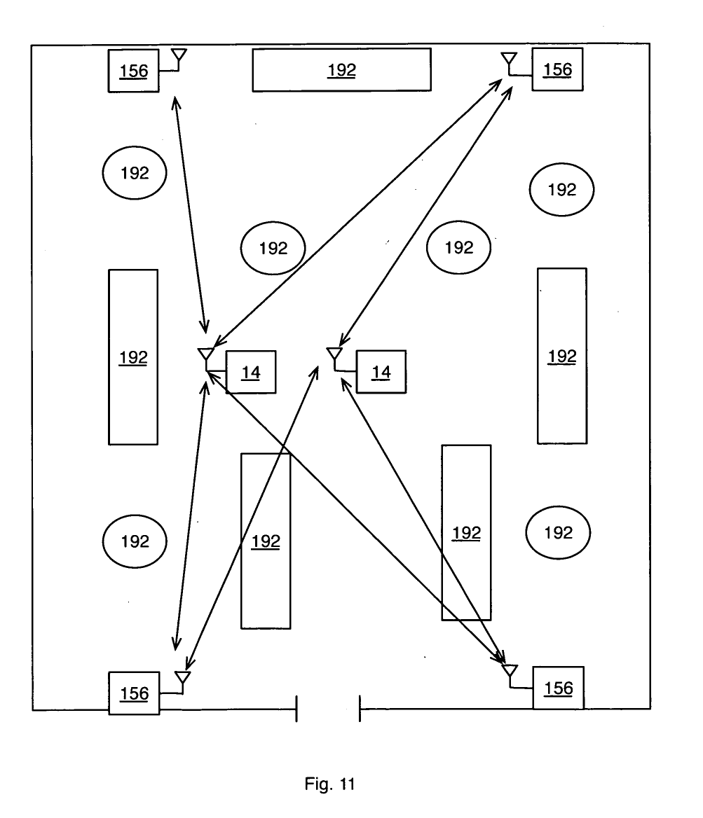

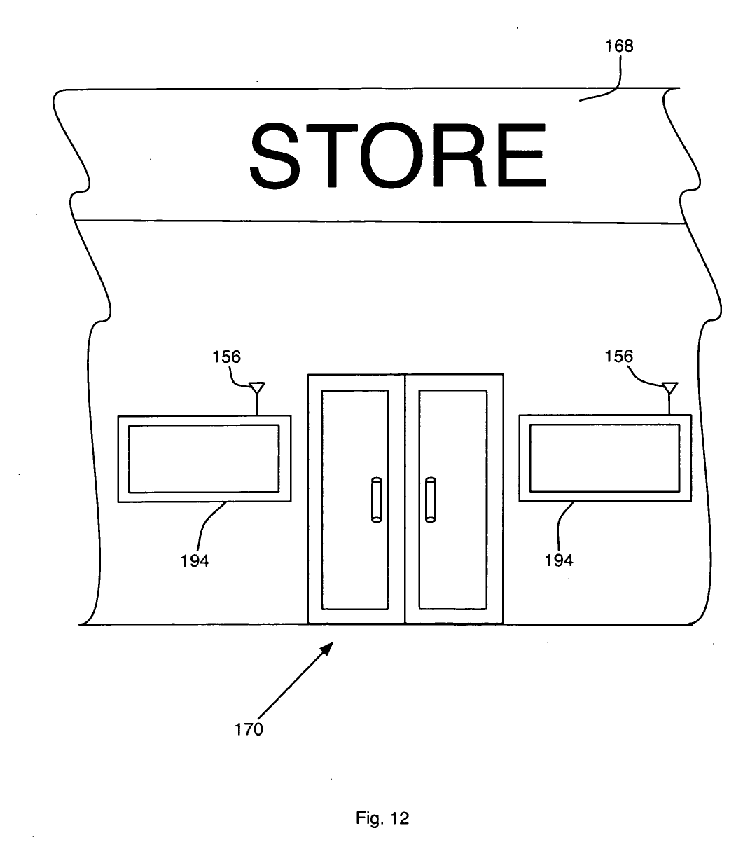

The inventor contemplates that various stores 168 may wish to provide an even more detailed level of routing, as shown in FIG. 11. The routing request made by the client 14 may extend beyond merely routing the client to the store. The routing manager 76 may route the user directly to the product location within a store 168 since many stores have consistent and detailed store layouts. To assist in providing this function, each store 168 may be equipped with its own location server 20 and additional WAPs 156 to help route the client 14 through the store 168 and to a particular display 192. The master server 18 could include all of the information for a particular physical environment. However, the inventor contemplates that it may be desirable to offload some of this more detailed information onto location servers 20, thus distributing the content information requests around the network and permit stores the ability to conveniently manage their own information and potentially allow for a centralized computer to push all of the data for their stores 168 in different physical locations across the world from one location (e.g., central server at corporate headquarters). The inventor further contemplates that this feature may be implemented in a variety of manners. The client 14 may be allowed to search all of the stores within the physical location once within the network via master server 18. Alternatively, the client 12 may be limited to searching with a particular store's 168 location server 20 once the location server 20 detects that the user has entered the store 168.

For many users, it is often difficult to find a particular item. Many stores are understaffed and may lack familiarity with the store themselves. Uniquely, this invention would allow the client to be routed to the particular location within the store where the particular item is located. The inventor contemplates that the client 14 may initiate a search for a product based on a variety of search criteria (product name, identifier, description, etc.) The client-initiated search is then forwarded to the master server 18 or the location server 20. The location of the product is located in the position database 72, 106 and located on the map database 82, 112 or the virtual view database 84, 116 and passed back to the client 14, which may be displayed on one of the views 176,178, 186 described above. In addition, the present invention could access one or more of the inventory databases 85, 117 to determine if the product is in stock, thus saving a great deal of frustration for the user endlessly searching the store 168 when the desired product is out of stock. If the product is out of stock, the client may be passed to the customer services server 22 and given the option to be provided information about when the next shipment is scheduled to arrive, reserve or preorder the product, arrange for home delivery, etc.

### 2. Tracking

Aside from routing clients 14 to a particular product, the routing manager 48 can also provide a tracking function as the client navigates through the physical environment which is stored in one or more of the position databases 38, 72, 106. Several aspects of the client's interaction within the physical environment 12 may be tracked. For instance, a timer may track the total time that the client 14 is within the physical environment 12, a particular store 168, or a particular location. This data could be used to assist with marketing efforts in a similar manner that “cookies” and the like provide such information to online retailers. Specifically, a retailer could analyze the effectiveness of a store display, the layout of the store, etc. to optimize the effectiveness of their marketing efforts and store organization. The tracking function could highlight displays 192 that are particularly effective or have lost their interest with users. In addition, this information could be correlated with client profile data contained in one or more client profile databases 41, 68, or 102. These databases can contain a variety of information including but not limited to the user's age, sex, height, weight, sizes, eye color, skin tone, education, income, purchasing history, etc. In addition, the information could be correlated with client preference data contained in one or more of the client preference databases 36, 76, 108. These databases may contain a variety of information including but not limited to the user's favorite color, clothes, sports, hobbies, television shows, actors, musicians, athletes, songs, movies, art, animals, etc.

Since the present invention is connected to a network such as the internet, it is also contemplated that client profile and client preference data may be correlated with the user information from a variety of online locations. For instance, client preference and client profile information may be input to the present invention 10 from internet data collection systems such as “Cookies.” when the client is surfs the internet or their internet search terms entered on sites such as Google, Bing, or Yahoo when using their client device. In addition, data about clients may be input from social networking games such as Farmville tm marketed by Zynga, Inc. This data could be correlated with the particular client in variety of manners (entry of a client ID, name, telephone number, email address, or other identifier.) Combining this information could prove to be very valuable to help stores determine the effectiveness of their store 168, the layout, or particular displays 192 to monitor and enhance their effectiveness in a noninvasive manner.

### 3. Targeted Advertising

In another aspect of the present invention, the inventor contemplates that the system 10 could be used to provide targeted advertising to the client 14. In addition to the profile data and the preference data described above concerning tracking the client 14 through the physical environment 12. The advertising manager could use the client profile data or client preference data to select a customized advertisement. For instance, if the preference data includes a field identifying the user's favorite color or favorite animal. If the selected advertisement is for a sweater, the color of the sweater in the advertisement may be depicted with the client's favorite color and their favorite pet added in as well. For another client, their favorite color and pet would be included in the advertisement. To further engage the user, the client user profile data contained in client profile database 13, 86, 116. For instance, if the user's name is Bill, the advertisement may mention Bill's name in the advertisement (e.g., “Bill, you would look great in this sweater!”). The master server 18 could also correlate information from social networking sites via the social networking manager 52, 92 with the advertising manager 78. The user could list their username on various social networking sites such as myspace, or facebook which would be correlated with the client 14. Avatars, photos, images, favorite phrases, and profile and preference data could be mined from the identified social networking sites and used to further customize advertisements. For instance, the background for an advertisement could be a picture uploaded by the user on a social networking. site. Or, the music played in the background of an advertisement could be the user's favorite song as identified on a social networking site. Or, the user's avatar could be included in the advertisement as a character. In addition, the advertisement could be selected based on the user's purchasing history or preferences.

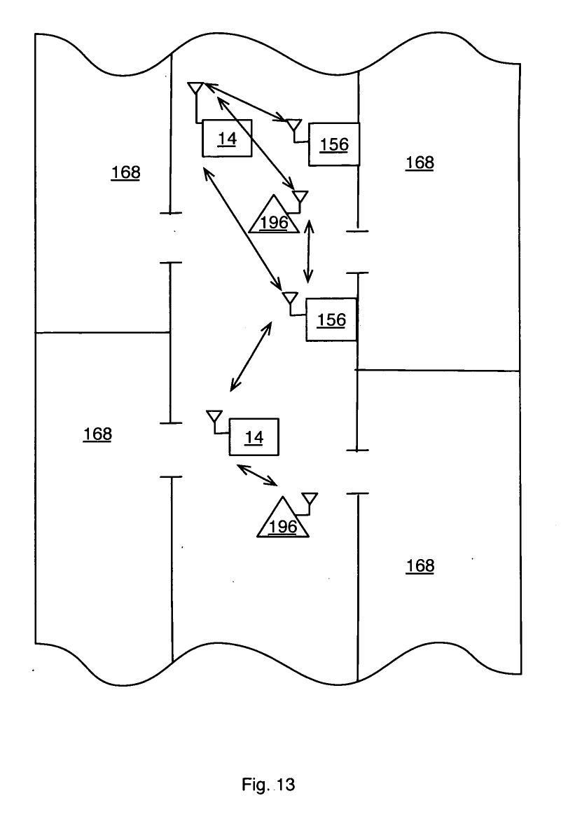

The advertisement may be provided to the user in a variety of manners. For instance, the advertisement may be provided directly to the user via the user interface 26 on the client 14. Alternatively, as seen in FIG. 12, the advertisement may be routed to a viewing station 194 having a WAP 156 so that as the client 14 passes the store 168 the station 194 displays the customized user targeted advertisement. In addition, as seen in FIG. 10, the advertisement could be displayed on a kiosk 196 having a WAP 156 in the physical environment 12. As various clients 14 pass by the station 194 or kiosk 196, an advertisement is selected and transmitted to the station 194 or kiosk 196 while the client 14 is proximate the station 194 or kiosk 196. As described above, the future location of the client may be predicted so that an advertisement can be timed to correlate with the location of the client. For instance, the advertisement can be sent to the client device 14 at, or perhaps a little before, the client is projected to pass a store 168 which the advertisement pertains to. Or, the advertisement could be sent to the station 194 or kiosk 196 when they pass the client is forecast to pass the kiosk or station.

### 4. Customer Services

Once the user has found a product or service of interest, the client may solicit customer services over the network 24. The customer services available may be correlated with products or services proximate the detected client location or correlated with stores proximate the detected client location. The request for customer services could be routed back to an in-store customer service associate. Alternatively, the request could be sent to the customer service manager 56, 98, or to customer service server 22. The request could be entered into the client via the user interface 26. Specifically, the user could enter a product ID, or other identifying information, into the client 14 and request customer services for the item. Alternatively, the client could take a picture of the product, bar code, or matrix bar code (such as a QR tag) with camera 29 in the client and send it to the customer service manager. In addition, the client could be connected via an audio and/or video connection to communicate the product ID or other identifying information to the customer service manager via audio and/or video communications. As discussed above, the customer services server 22 or manager 54, 98 may route the request to an expert. Alternatively, the request could be routed to a manufacturer's data such as product descriptions, manuals, users guides, videos describing the product, advertisements, and the like.

The customer services may be correlated with the client profile and preference data to help assist customer service. Knowing that the request came from someone with a particular profile or preferences help the them to tailor their advice or route the request in a particular manner to enhance the customer service experience. For instance, depth of information about a product that is given to a PhD in Engineering from MIT about a product may be different that the information desired and provided to a senior citizen. In addition, customer service may be able to access the past purchase history of the client and make suggestions (e.g., “you just bought a red shirt last week, that would look great with our new blue skirt, would you like to be routed there”). In addition, you could enter a given product and ask for suggested matches. (e.g., “people who bought this item also bought this other item,” or “we would suggest that this item would go great with the item you identified.”). The inventor contemplates that integrating internet-based customer services into physical locations would greatly enhance the user experience.

### 5. Position-Based Social Networking

Another unique aspect of the present invention is that it may be used to enhance social networking. Rather than interacting with individuals in a virtual world online. The inventor contemplates that social networking programs can be used to augment and enhance the physical environment. The users can interact with other users via their client devices 14. Similar to online social networking, the inventor contemplates that the present invention could be used to map clients 14 on a map displayed on each other client device 14. Essentially integrating location data at a physical location 12 with social networking. A given client 14 may be able to select a different client shown on the map and communicate via voice, text, or videoconferencing using their client device 14. In addition, the present invention could allow the users to interact with one another in “chat rooms” or “fan pages” which may be open to all users, restricted to particular user groups (e.g., CITY High School Seniors) or restricted by invitation only (e.g., Mrs. Miller's 3^{rd} grade class only!). Fan rooms could be implemented within the social networking manager 80 which is focused on fans of a particular store, students from a particular school, student in a particular class, hobbies, etc. They may be open to the public or could be private requiring a moderator to provide the password. The potential options are endless. The user groups could be set up by users themselves, the stores, or other moderators.

The present invention also contemplates that one client 14 may view other clients 14 within the physical location 12. For instance, the client 14 may be able to view all clients 14 within the physical location 14. Alternatively, the client could restrict the view based on the social networking mentioned above to see the members of a particular user group, or fan group. Alternatively, the client may be able to restrict the view to a user-programmed list of associates contained in the associates' database 39. The associate's database 39 may contain a list of any one or more identifiers including but not limited to client IDs, email addresses, etc. The associates may permit their identification and location to be passed to other associates within the physical location. Advantageously, users can find other users within the physical location, thus avoiding the situation where two users were at the same location and would have liked to meet each other but didn't know the other one was there. In addition, the present invention can provide assistance in helping two clients 14 locate each other when they were scheduled to meet at a particular time and particular location. Ideally, the client devices 14 are capable of telephone calls so they can call each other. Alternatively, one client 14 could be routed to the other client 14 though use of the routing manager 48.

In addition to the above, the inventor contemplates that the present invention can be used to enhance traditional social networking. Location based information could be used to provide small location based virtual rooms, fan site or bulletin boards. As the client device 14 enters a store 168 it may receive a message by text message, or identified on the map view or virtual view that there are virtual bulletin boards within the environment. For instance in a music store, they may see that someone started a bulletin board about their favorite blues musicians in the blues section. Or, in front of the newest release from a musician the store or other clients may post their views about the artist or the new release. The client 14 can read others view and perhaps post their own views on the topic if of interest. Or, for example, with respect to a sports area, virtual messages could be left associated with a particular seat.

### 6. Safety and Security

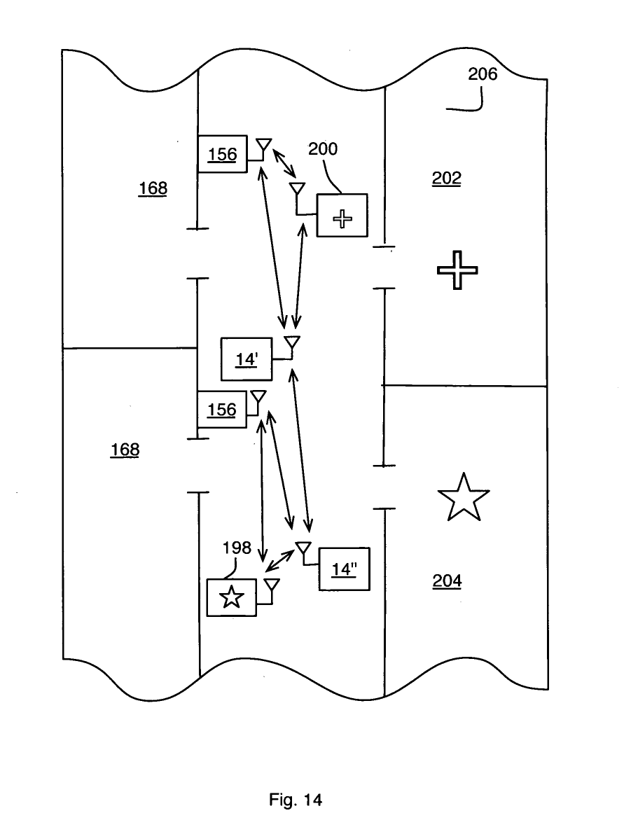

The social networking information may be used to enhance the safety of the users. For instance, the client 14 could be used to indicate the location of safety or security personnel as show in FIG. 14. If the user becomes lost, hurt or fears for their safety, the distressed client device 14′ could have a search function to locate the nearest security officer 198 or medical officer 200. The routing manager 48, as described above, could be used to direct the client 14′ to a designated safety officer device 198 or medical officer device 200 or visa versa. Alternatively, rather than routing the client 14′ to a safety officer device 198 or medical officer device 200, the client device 14′ could be programmed to route the client 14′ to a designated medical office 202 or security office 204 or visa versa. Still further, the present invention could be programmed to highlight the distressed client device 14′ on another device (e.g., set off a buzzer, flash on the screen, etc). For instance, the client 14′ could activate a panic mode if they need help by pressing a button, shaking the device vigorously (using the internal accelerometer), a combination of key strokes (e.g., press and hold the send button, not shown, for 3 seconds, etc.), and the like. The signal could be sent to the security officer 198 or medical officer 200, a caregiver device 14″, a device in the medical office 200, or a device in the security office 202 to notify them that user needs assistance. In response, the present invention 10 could provide the medical officer 200, security officer 198, or caregiver 14″ with directions to the distressed client 14′.

### 7. Synthetic Reality Gaming

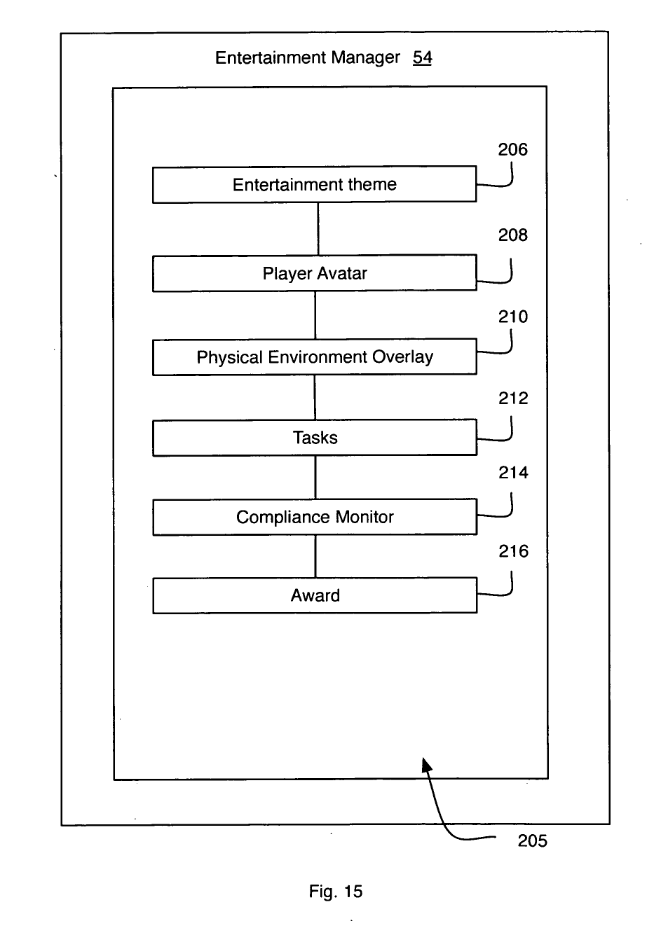

Anther unique aspect of the present invention is that it could be used to provide a synthetic reality, multiuser game 205 in the physical environment 12 as shown in FIG. 15. The entertainment manager 54 may be used to provide a multiuser gaming environment recasting the physical environment with a variety of themes 206. A variety of themes could be selected such as a western theme, an outer space theme, a 1950's theme, an inner city gang theme, a Christmas theme, a medieval theme, a murder mystery theme, a pirate theme, a treasure hunt, a haunted house, etc. The clients could select an avatar from the available player avatars database 208. In the virtual view 186, the client avatar may be displayed on the screen 172. In addition, the physical environment can be overlaid with an physical environment overlay 210. The physical environment overly would take the data from the virtual view database 84 and/or the Map database 82 and overlay an entertainment theme. As the clients 14 move through the physical environment they may encounter other clients 14 playing the game and may be asked to perform various tasks contained in the task database 212. Compliance with the task could be determined and stored in the compliance monitor 214. Successful compliance could be rewarded with points and prizes, which are stored in the awards database 216.

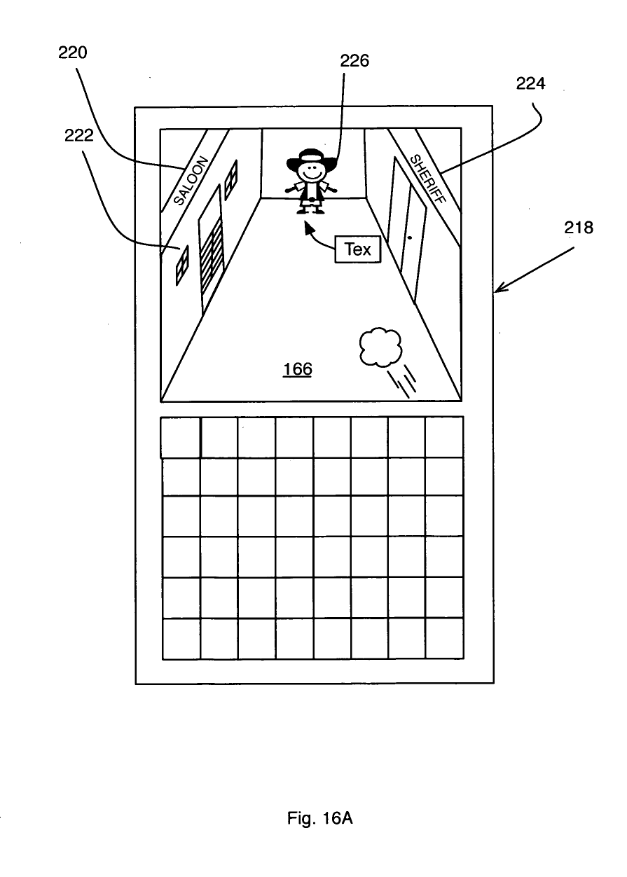

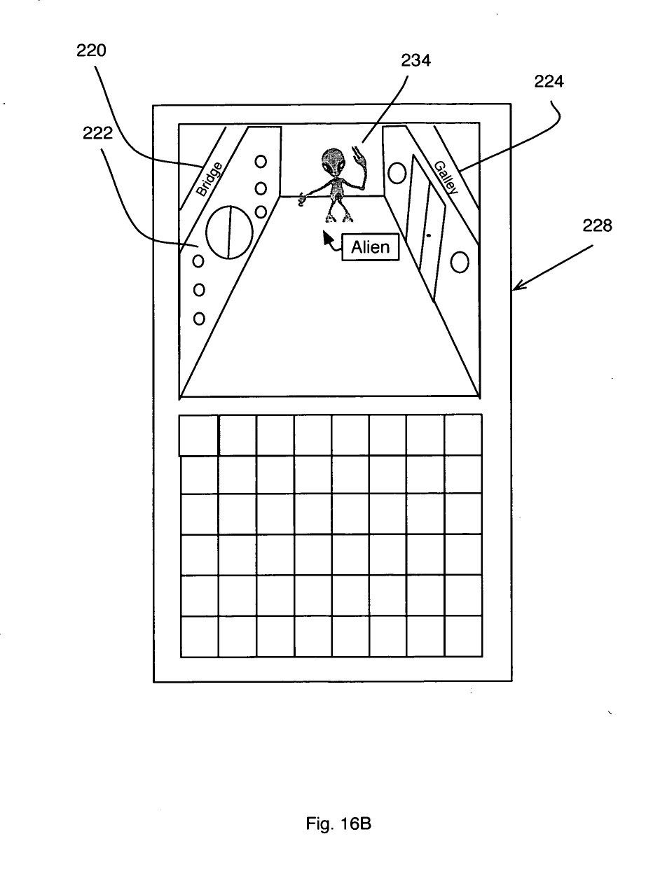

By way of example, the inventor contemplates that a physical environment 12 may decide to stage a western themed game (as shown in FIG. 16A). The stores 168 could be modified from their real appearance and shown in a western theme 218. For instance, a food store in the physical environment could be shown as a western saloon 220 where the real store is located 168 complete with louvered saloon doors 220 where the real doors 170 are located in the physical environment 12. As the client walks down the hallway 166 the other clients 14 may be displayed with their selected avatar from the avatar database 208 such as cowboy 226. The security office 204 could be shown as the sheriffs office 224. Alternatively as shown in FIG. 16B, the physical environment 12 could be shown as a space theme 228. One of the stores 168 could be depicted as a starship command bridge 230 or a starship galley 232. The other clients 14 may be displayed with theme appropriate avatars such as alien 234.

To enhance the game 205, the clients may decide to dress up in theme appropriate attire (e.g. wear a cowboy outfit, or an alien costume). The stores 168 could also participate. For instance, if at a given time the mall is sponsoring a western themed game 218, the employees working in the stores or hired actors may wear theme appropriate costumes. In addition, the stores 168 may offer special items for sale consistent with the game. For instance, a store may offer for sale a theme appropriate product (e.g. denim skirts and cowboy hats when the game theme is western, drinks sold in souvenir tin cups, etc.). Alternatively, if the theme is the 1950's, a store may offer a special on hamburgers and root beer floats.

As mentioned above, the game may include a variety of tasks 212. The tasks may be simple such as find a new store, find a new product, find the product and write a review, find another client, find a particular location. Once found, compliance could be verified by the compliance database 214 in a variety of ways, compliance could be determined by individuals, not shown, who are given the responsibility to monitor compliance. They could verify completion and provide the client with a code to enter on their client device 14 which is sent to the entertainment manager to indicate that the client has successfully completed the task, they could take identifying information from the client and enter it into their own client device to indicate that the identified client has completed the given task. Or, compliance could be determined simply when the client 14 is detected at a selected location. Or, compliance could be detected when they take a picture of with their camera 29 of the correct item and send the picture to the compliance monitor 214 for verification. Aside from simple tasks, the client 14 could also be presented with a more challenging game where they are given clues or riddles that they need to figure out where they need to go and what they need to do. The entertainment manager 54 could include electronic games embedded into the game 205.

The stations and kiosks could be programmed to provide entertainment content periodically. For instance, if a game is being played within the environment 12 such as a pirate adventure. The game could include teams of clients 12 within the physical environment set out to work together or against each other to achieve a particular task. As the clients 14 move through the physical environment near the kiosks 196 and stations 194, the kiosks and stations may display entertainment content (e.g. A pirate may be displayed discouraging the client from continuing down the hallway 166 as the client passes by the kiosk or station). Or, once a particular location is found, the client may have to beat an electronic depiction of a cowboy in a poker game. The poker game may be displayed on a client device 14, a station 194, or a kiosk 196. In addition, an accelerometer 27 equipped client device 14 could be used to monitor compliance with physical challenges. For example, once again, if the game is a western theme 218 one portion of the game may require the client 14 to ride a horse. They accelerometer as it is shaken could be used to represent the horses speed. Or if the theme is a pirate adventure, one portion of the game may require the client to row a boat to an island. The entertainment manager 54 could be programmed to receive the accelerometer data and correlate the detected motion with the speed at which the row boat moves. To enhance the game, the clients 14 could be divided into teams and given tasks that require team participation, thus providing the users with a fun way to interact with one another.

The tasks could be supported by advertising programs. For instance, if a store 168 wishes to increase traffic through their store or increase the “buzz” about a product, the store 168 could sponsor a challenge, which is rewarded with a prize from their store 168. Or, the challenge may require that the user go to a store find a code, take a picture, etc. The awards database 216 manages and store the data related to awards. The awards may be points, virtual cash, cash, or coupons redeemable for real world prizes (e.g. free small ice cream cone, 10% off of purchase). The inventor contemplates that the physical location 12 could provide users with a developer's toolkit, which would allow users to create their own games within the physical environment 12. The kit could provide standard themes, tasks, and awards. Alternatively, the users could create and upload their own content. The users could thus play multiple different games during on visit to the physical environment or multiple groups could play different games simultaneously.

### D. Alternative Physical Environments

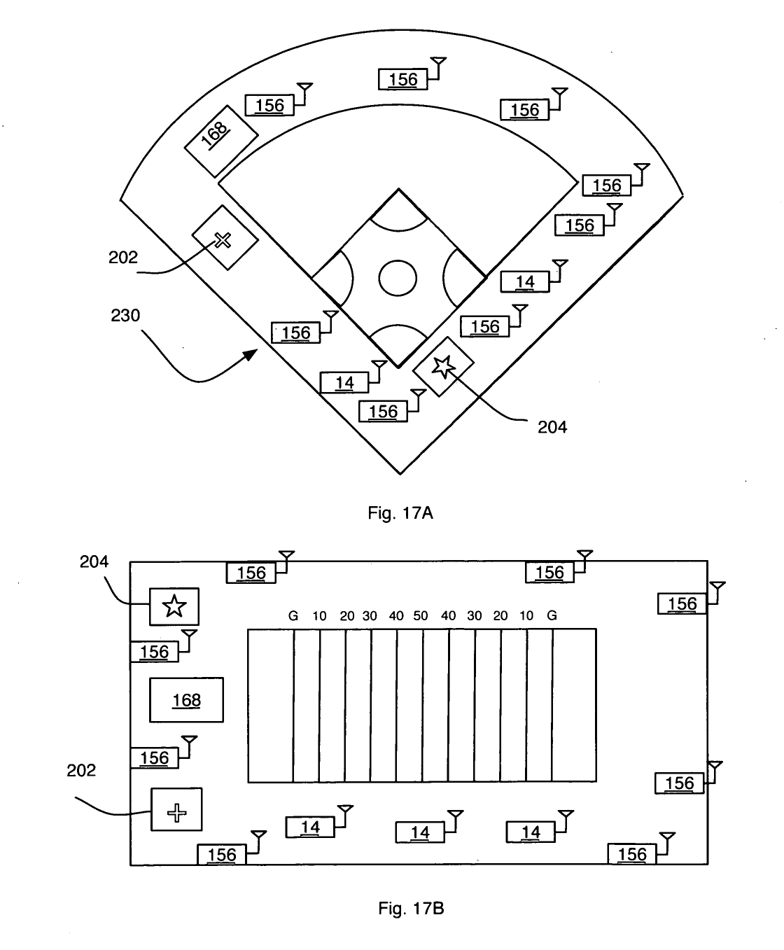

As seen in FIGS. 17A and 17B the present invention could be used in a variety of different applications rather than merely the shopping mall example used thus far. For instance the present invention could be used in a baseball park 230 as shown in FIG. 17A or a football stadium 232 as shown in FIG. 17B. Of course a variety of other venues are contemplated as well such as theaters, airports, hospitals, stores, shopping districts, schools, parks, museums, zoos neighborhoods, convention centers, or even entire cities or portions of the country.

For example, the inventor contemplates that the present invention could be used to enhance the user experience at an area. The system could be used to provide turn-by-turn directions to the user's seat. The system could be used to find and allow communications with associates at the venue. The system could help the user find a product or service of interest, and even indulge in entertainment/games, locate associates or leave and access geo-referenced content at a particular location. For the venue operator, they can provide targeted advertising, monitor user habits, etc. To provide a few more non-limiting examples, the present invention could help route an air traveler to their gate, baggage carousel, desired ticket counter, or restaurant. It could also notify the air carrier where the client is and allow them to hold a flight since they can see that the user is on their way, and even forecast the client's anticipated arrival time. It also could notify a user when friends or associates have entered the airport. In addition, customized games may be provided allowing the users to enhance their user experience. Another potential application is in schools. For college kids away from home for the first time trying to find their way around campus and meet new people can be a daunting task. The present invention could make it easy and fun to find where your professor's office, classroom, laundry room, cafeterias are located. The present invention could be used to provide museum, park, or zoo patrons with an enhanced user experience. For instance, the zoo could provide information about the animals viewed in a particular location within the zoo. The information provided could be customized based on the client preference and profile information.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. In addition, it is impracticable to identify every conceivable location and organization of the present invention. The invention places particular management features databases where deemed presently most desired. However, in a particular application, the location and organization of the particular management features and databases may be relocated and reorganized without departing from the scope of the present invention.

What is claimed is:

1. A system for augmenting a physical environment with content comprising:
a global positioning system;
a master server comprising a session manager, a communications manager, and databases;
a client comprising a user interface, a session manager, a communications manager, and a location manager, wherein the location manager is in communication with the global positioning system to determine the client location, the communications manager is in communication with the master server via a network such that information may be sent and received between the master server and the client, wherein the client is provided customer services available proximate the customer location, wherein the client is configured to submit a request for customer services, and wherein the client receives a customer services response.

2. The system of claim 1, wherein the customer services provided are correlated with products proximate the determined client location in the physical environment.

3. The system of claim 1, wherein the customer services are correlated with a store proximate the determined client location in the physical environment.

4. The system as recited in claim 1, wherein the request for customer services includes a product identifier.

5. The system as recited in claim 4, wherein the product identifier is a product ID.

6. The system as recited in claim 4, wherein the product identifier is a photo.

7. The system as recited in claim 4, wherein the product identifier is a bar code.

8. The system as recited in claim 4, wherein the product identifier is a matrix bar code.

9. The system as recited in claim 1, wherein the system further comprises a customer services server, wherein the request for customer services is directed to the customer services server.

10. The system as recited in claim 4, wherein the request for customer services includes the client location.

11. The system as recited in claim 1, wherein the master server includes a client profile database and client preferences database, and wherein client profile data for the client and client preference data for the client is correlated with the customer services request.

12. A system for augmenting a physical environment comprising:
a global positioning system;
a master server comprising a session manager, a communications manager, and databases;
a client comprising a user interface, a session manager, a communications manager, and a location manager, wherein the location manager is in communication with the global positioning system to determine the client location, the communications manager is in communication with the master server such that information may be sent and received between the master server and the client, wherein the system includes a routing manager, wherein the routing manager routes the client to a product location within the physical environment.

13. The system of claim 12, wherein the global positioning system is one or more of the following:
a satellite-based global positing system,
a terrestrial-based global positing system, or
a wireless local area network based positioning system.

14. The system of claim 12, wherein the global positioning system is a wireless local area network comprising a plurality of wireless access points, wherein the client determines the client location in the physical environment based on the signal strength of each wireless access point of the plurality of wireless access points.

15. The system of claim 12, wherein the global positioning system is a wireless local area network comprising a plurality of wireless access points, wherein the client determines the client location in the physical environment based on the signal latency of each wireless access point of the plurality of wireless access points.

16. The system of claim 12, wherein the routing manager provides turn-by-turn directions to the client.

17. The system of claim 12, wherein the routing manager depicts a virtual environment on the client user interface correlated with the physical environment.

18. A system for augmenting a physical environment comprising:
a global positioning system;
a master server comprising a session manager, a communications manager, and databases;
a client comprising a user interface, a session manager, a communications manager, and a location manager, wherein the location manager is in communication with the global positioning system to determine the client location, the communications manager is in communication with the master server such that information may be sent and received between the master server and the client, wherein the system includes a routing manager, wherein the routing manager routes the client to a product location, wherein the client is provided customer services available proximate the customer location, wherein the client is configured to submit a request for customer services, and wherein the client receives a customer services response.

19. The system as recited in claim 18, wherein the master server includes a client profile database and client preferences database, and wherein client profile data for the client and client preference data for the client is correlated with the customer services request.
